(19) United States
(12) Patent Application Publication
(10) Pub. No.: US 2016/0189247 A1
(43) Pub. Date: Jun. 30, 2016

(54) USER INTERFACES FOR MANAGING ADVERTISING CAMPAIGNS

(71) Applicant: Facebook, Inc., Menlo Park, CA (US)

(72) Inventors: Jonathan Howarth Chester, Northport, WA (US); Ter Chrng Ng, Seattle, WA (US); Saif R. Hasan, Redmond, WA (US)

(21) Appl. No.: 14/584,055

(22) Filed: Dec. 29, 2014

(51) Int. Cl. G06Q 30/02

(52) U.S. Cl. CPC G06Q 30/0277; G06Q 30/0275

(57) ABSTRACT

An online advertising system enables advertisers to create a new advertisement campaign and then upload a plurality of advertisement sets and rules for targeting, prioritizing, and frequency capping the advertisement sets. Within each advertisement set, the advertiser provides one or more creative groups of advertisements along with weightings or sequencing among the creative groups in the advertisement set. The online advertising system provides a summary user interface that presents the advertiser's purchased advertisement placements across all publishing sites. From the summary user interface, the advertiser can select an advertisement placement, which results in an editor user interface being presented that presents the details of the selected advertisement placement. The advertiser can then modify the selected advertisement placement, which is automatically updated in the summary user interface.

### BACKGROUND

This disclosure relates generally to managing advertisement campaigns, and more particularly to user interfaces that facilitate assignment of advertisements to ad placements in advertisement campaigns.

Advertisers regularly purchase advertisement placements from publishing systems that provide content to users. There may be restrictions associated with the purchased ad placements. For example, the advertisement placement may require an advertisement of particular dimensions or type (e.g., only images—no animations). Advertisement servers typically only have a limited set of advertisements that are associated with specific targeting criteria and are formatted in a specific manner (e.g., set dimensions and set type). Additionally, advertisement servers are not able to automatically re-format advertisements to satisfy the requirements of the ad placement. Accordingly, the advertisement server may be limited in which ad placements it can fill with advertisements.

Moreover, management of advertisement campaigns can be extremely onerous on advertisers. For example, an advertiser may have purchased many advertisement placements (e.g., hundreds, thousands, etc.) which the advertiser then has to manually assign advertisements. Compounding the difficulty is that the ad placements generally have different restrictions such that only certain advertisements may be assigned to certain ad placements.

### SUMMARY

An online advertising system stores a plurality of advertisement (ad) sets. Each ad set is associated with one or more creative groups. A creative group comprises one or more ad assets (advertisements) that are associated with an advertising concept, and the ad assets have their own respective sets of asset parameters. In some embodiments, a creative group only has one advertisement. The online advertising system also stores one or more ad placements, purchased by an advertiser, for advertisements for one or more publishing systems.

The online advertising system generates a summary user interface based on the one or more ad placements and the one or more ad sets. The summary user interface includes the advertiser's purchased one or more ad placements for the one or more publishing systems. The summary user interface is then provided to a user (e.g., the advertiser).

The online advertising system receives, via the summary user interface, a selection of an ad placement, of the one or more ad placements being presented to the user. Responsive to the selection, the online advertising system provides an editor user interface to the user. The editor interface includes placement details about the selected ad placement. Placement details provide information about the ad sets associated with the ad placement (e.g., a description of ad sets within the ad placement, description of advertisements within the ad sets, bid prices of the ad sets within the ad placements, bid prices of advertisements within the ad sets, targeting criteria associated with advertisements within the ad sets, frequency information associated with advertisements within the ad sets, click-thru URLs associated with advertisements within the ad sets, etc.). The online advertising system automatically updates the summary user interface based on information received via the editor user interface which modifies one or more of the placement details associated with the selected ad placement.

### BRIEF DESCRIPTION OF THE DRAWINGS

FIG. 1 is a block diagram of a system environment in which an online advertising system operates, according to an embodiment.

FIG. 2 is a block diagram of an online advertising system, according to an embodiment.

FIG. 3 is a flowchart illustrating a process for generating a creative group, according to an embodiment.

FIG. 4 is a flowchart illustrating a process for serving advertisements using advertisements in creative groups, according to an embodiment.

FIG. 5 is a flowchart illustrating a process for updating a summary user interface, according to an embodiment.

FIG. 6 illustrates a creative group user interface that allows a user to edit a creative group, according to an embodiment.

FIG. 7 illustrates a notification user interface that notifies a user that the dimensions of an advertisement are out of compliance with standard dimensions, according to an embodiment.

FIG. 8 illustrates an assignment user interface that enables a user to assign advertisements to advertisement placements, according to an embodiment.

FIG. 9 illustrates a summary user interface that allows a user to review advertisement placements, according to an embodiment.

FIG. 10 illustrates an editor user interface that allows a user to edit individual advertisements placements, according to an embodiment.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

### System Architecture

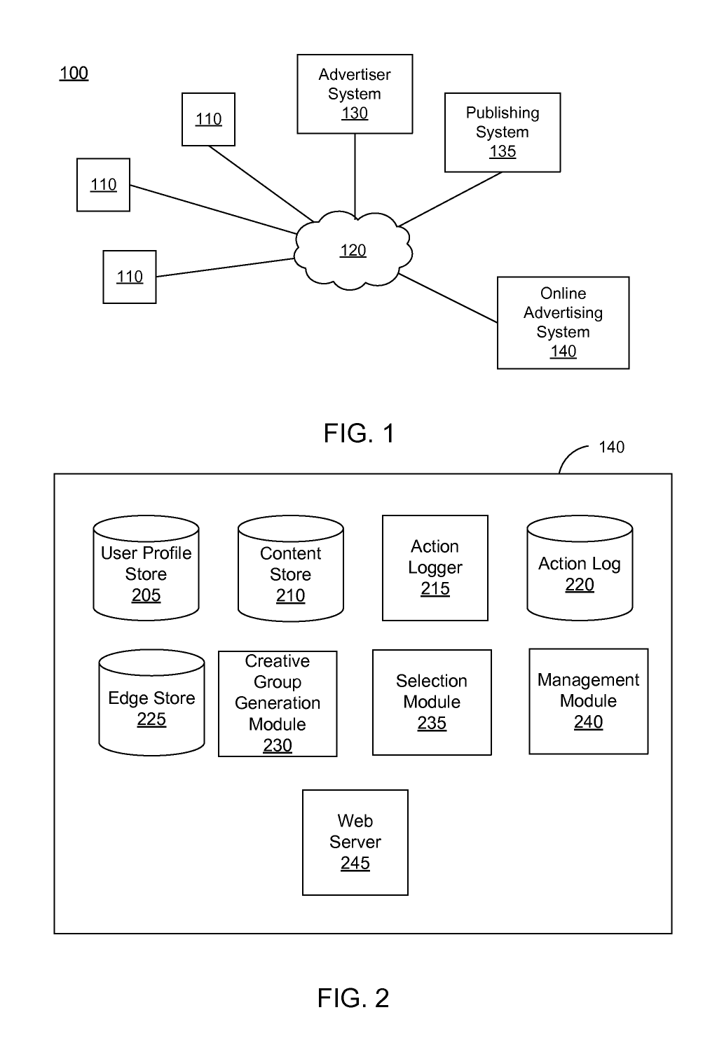

FIG. 1 is a high level block diagram of a system environment 100 for an online advertising system 140. The system environment 100 shown by FIG. 1 comprises one or more client devices 110, a network 120, one or more advertiser systems 130, one or more publishing systems 135, and the online advertising system 140. In alternative configurations, different and/or additional components may be included in the system environment 100. The embodiments described herein can be adapted such that the functionality of the online advertising system 140 is spread out over multiple systems. For example, the online advertising system 140 may be coupled to a separate social networking system instead of including the functionality of the social networking system within the online advertising system 140.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online advertising system 140 and/or the publishing system 135. For example, a client device 110 executes a browser application to enable interaction between the client device 110 and the online advertising system 140 and/or the publishing system 135 via the network 120. In another embodiment, a client device 110 interacts with the online advertising system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more advertiser systems 130 may be coupled to the network 120 for communicating with the online advertising system 140, which is further described below in conjunction with FIG. 2. The advertiser system 130 communicates information to the online advertising system 140, such as advertisements. In some embodiments, an advertiser may use a client device 110 to provide advertisements to the online advertising system 140.

One or more publication systems 135 may be coupled to the network 120 for communicating with the online advertising system 140, which is further described below in conjunction with FIG. 2. In some embodiments, a publication system 135 provides content or other information for presentation via a client device 110. A publication system 135 may also communicate information to the online advertising system 140, such as advertisements, content, or information about an application provided by the publication system 135.

The publishing system 135 publishes content to viewing users. In some instances, the content includes one or more slots for advertisements. The publishing system 135 sells the slots to advertisers as ad placements. The online advertising system 140 receives ad placements and advertisements from advertisers. As discussed below, responsive to receiving a request for an advertisement from a publishing system 135, the online advertising system 140 selects an advertisement and provides the selected advertisement to a viewing user of the content and/or the publishing system 135.

FIG. 2 is an example block diagram of an architecture of the online advertising system 140. The online advertising system 140 shown in FIG. 2 includes a user profile store 205, a content store 210, an action logger 215, an action log 220, an edge store 225, a creative group generation module 230, a selection module 235, a management module 240, and a web server 245. In other embodiments, the online advertising system 140 may include additional, fewer, or different components for various applications. Conventional components such as network interfaces, security functions, load balancers, failover servers, management and network operations consoles, and the like are not shown so as to not obscure the details of the system architecture.

Each user of the online advertising system 140 is associated with a user profile, which is stored in the user profile store 205. A user profile includes declarative information about the user that was explicitly shared by the user and may also include profile information inferred by the online advertising system 140. In one embodiment, a user profile includes multiple data fields, each describing one or more attributes of the corresponding user of the online advertising system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online advertising system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online advertising system 140, user profiles may also be stored for entities such as businesses or organizations. This allows an entity to establish a presence on the online advertising system 140 for connecting and exchanging content with other online advertising system users. The entity may post information about itself, about its products or provide other information to users of the online advertising system using a brand page associated with the entity's user profile. Other users of the online advertising system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online advertising system users may create objects stored by the content store 210, such as status updates, photos tagged by users to be associated with other objects in the online advertising system 140, events, groups or applications. In some embodiments, objects are received from third-party applications or third-party applications separate from the online advertising system 140. In one embodiment, objects in the content store 210 represent single pieces of content, or content “items.” Hence, users of the online advertising system 140 are encouraged to communicate with each other by posting text and content items of various types of media through various communication channels. This increases the amount of interaction of users with each other and increases the frequency with which users interact within the online advertising system 140.

The content store 210 stores one or more advertising campaigns received from one or more advertisers and/or advertising systems 130. Additionally, the content store 210 stores ad placements, purchased by advertisers, for advertisements for one or more publishing systems 135. An ad placement is a location on a content page for display of an advertisement. In some embodiments, the ad placement may be a location within a messaging thread between two or more users in a messaging application (e.g., WHATSAPP, MESSENGER, etc.). Advertisers purchase ad placements on various content pages across various publishing systems 135, and utilize the online advertising system 140 to select and provide advertisements to fill the purchased ad placements. An advertising campaign describes how ad sets are used to fill ad placements that have been purchased by an advertiser. An advertiser may have multiple different advertising campaigns each for a different product (e.g., mobile phone, tablet, laptop) or for the same product but targeted to different groups of users (e.g., mobile phone campaigns for women vs. men). The advertiser associates the advertising campaigns with the one or more ad placements that have been purchased by the advertiser and a plurality of ad sets that each are associated with a respective set of selection rules. An ad set is a collection of creative groups and/or advertisements (i.e., creative groups with a single ad asset). For example, an advertiser might have multiple different ad sets the advertiser has selected for a particular ad placement that advertiser has purchased, and each ad set might include different ads/creative groups for a particular target group of viewers (e.g., for females age 20 to 30, the ad set might include a mobile phone ad, a tablet ad, and a computer ad; for men age 18 to 20, the ad set might include only a mobile phone ad). The ad sets are stored in the content store 210.

A creative group is a group of one or more ad assets (also referred to as advertisements) that are all associated with the same advertising concept, and each ad asset is associated with its own set of asset parameters. For example, a creative group might include the copies of the same ad, each having different dimensions. The advertising concept describes what the ad asset is advertising to the user. For example, in some embodiments, the advertising concept is a particular image (e.g., image of a mobile phone), and the ad assets are versions of the image that have different dimensions (e.g., a 300×250, 300×600, etc.). The ad assets within a particular group have one or more different asset parameters. The asset parameters describe specific features of the advertisement. Asset parameters may include, e.g., a size parameter that defines the dimensions of the advertisement, an advertisement type that indicates the type of advertisement (e.g., text, image, audio, animation, video, or any other suitable data presented to a user, etc.), targeting criteria, a bid amount, a click thru URL to a landing to which a user is directed when the advertisement is accessed, or some combination thereof. One or more of the asset parameters differ between the asset parameters of ad assets associated with creative group. For example, two ad assets may be of the same advertisement type, but have different size parameters (i.e., are of different dimensions).

The bid amount is associated with an advertisement by an advertiser and is used to determine an expected value, such as monetary compensation, provided by an advertiser to the online advertising system 140 if the advertisement is presented to a user, if the advertisement receives a user interaction, or based on any other suitable condition. For example, the bid amount specifies a monetary amount that the online advertising system 140 receives from the advertiser if the advertisement is displayed and the expected value is determined by multiplying the bid amount by a probability of the advertisement being accessed.

Targeting criteria included in an advertisement request specify one or more characteristics of users eligible to be presented with content in the advertisement request. For example, targeting criteria are a filter to apply to fields of a user profile, edges, and/or actions associated with a user to identify users having user profile information, edges or actions satisfying at least one of the targeting criteria. Hence, the targeting criteria allow an advertiser to identify groups of users matching specific targeting criteria, simplifying subsequent distribution of content to groups of users.

In one embodiment, the targeting criteria may specify actions or types of connections between a user and another user or object of the online advertising system 140. The targeting criteria may also specify interactions between a user and objects performed external to the online advertising system 140, such as on a publishing system 135. For example, the targeting criteria identifies users that have taken a particular action, such as sending a message to another user, using an application, joining a group, leaving a group, joining an event, generating an event description, purchasing or reviewing a product or service using an online marketplace, requesting information from a publishing system 135 or some other third party system, or any other suitable action. Including actions in the targeting criteria allows advertisers to further refine users eligible to be presented with content from an advertisement request. As another example, targeting criteria may identify users having a connection to another user or object or having a particular type of connection to another user or object.

The action logger 215 receives communications about user actions internal to and/or external to the online advertising system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online advertising system 140 to track user actions on the online advertising system 140, as well as actions on publishing systems 130 or some other third party systems that communicate information to the online advertising system 140. Users may interact with various objects on the online advertising system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the online advertising system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online advertising system 140 as well as with other applications operating on the online advertising system 140. In some embodiments, data from the action log 220 is used to infer interests or preferences of a user, augmenting the interests included in the user's user profile and allowing a more complete understanding of user preferences.

The action log 220 may also store user actions taken on a publishing system 130 or some other third party system, such as an external website, and communicated to the online advertising system 140. For example, an e-commerce website that primarily sells sporting equipment at bargain prices may recognize a user of an online advertising system 140 through a social plug-in enabling the e-commerce website to identify the user of the online advertising system 140. Because users of the online advertising system 140 are uniquely identifiable, e-commerce websites, such as this sporting equipment retailer, may communicate information about a user's actions outside of the online advertising system 140 to the online advertising system 140 for association with the user. Hence, the action log 220 may record information about actions users perform on a publishing system 130 or some other third party system, including webpage viewing histories, advertisements that were engaged, purchases made, and other patterns from shopping and buying.

In one embodiment, an edge store 225 stores information describing connections between users and other objects on the online advertising system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online advertising system 140, such as expressing interest in a page on the online advertising system 140, sharing a link with other users of the online advertising system 140, and commenting on posts made by other users of the online advertising system 140.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online advertising system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online advertising system 140 over time to approximate a user's affinity for an object, interest, and other users in the online advertising system 140 based on the actions performed by the user. A user's affinity may be computed by the online advertising system 140 over time to approximate a user's affinity for an object, interest, and other users in the online advertising system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

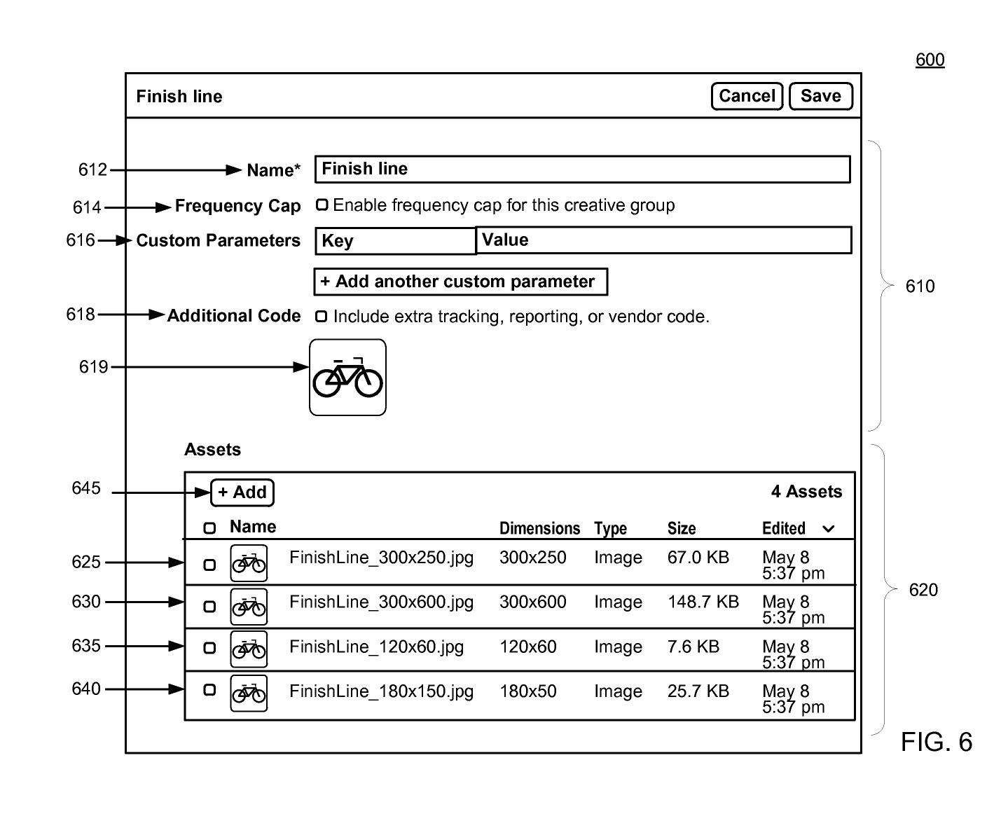

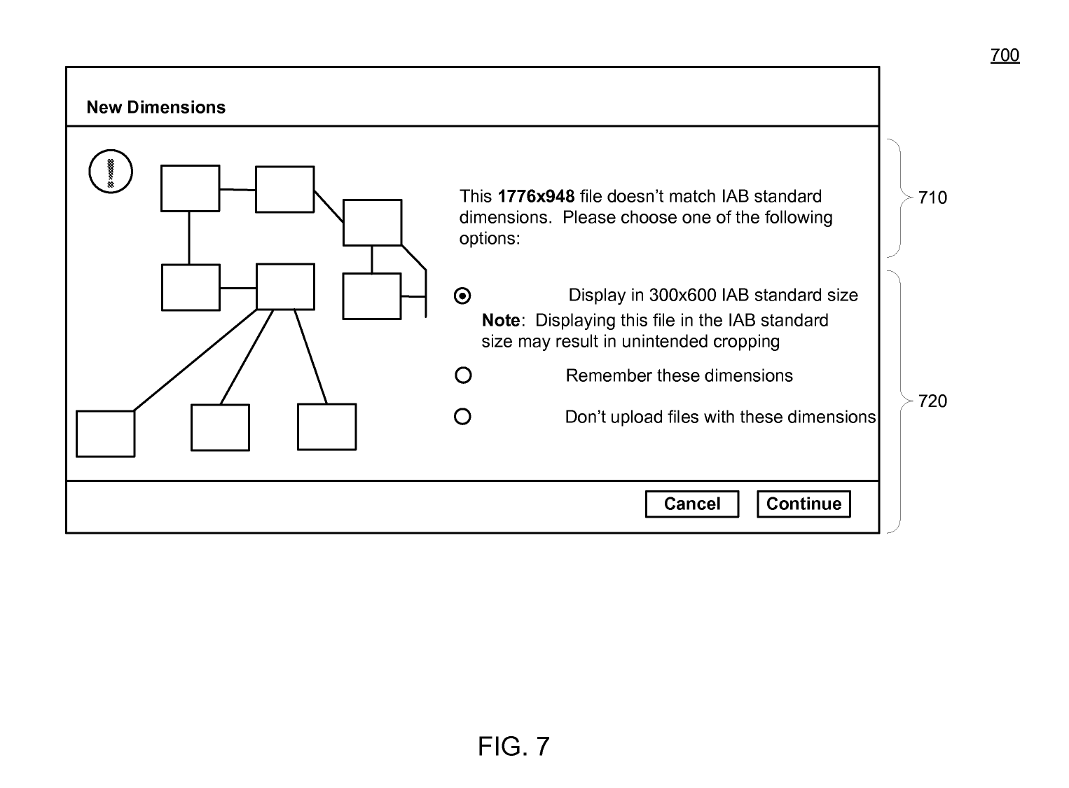

The creative group generation module 230 receives ad assets and their associated sets of asset parameters from advertisers via, e.g., a creative group user interface as described below with reference to FIG. 6. The creative group generation module 230 formats the received ad assets in accordance with one or more formatting rules. The creative group module 230 determines whether one or more of the asset parameters are in compliance with the one or more formatting rules. For example, the online advertising system 140 may check whether the dimensions of a received ad asset are in compliance with standard advertisement dimensions, whether an advertisement type (e.g., text, image, audio, animation, video, etc.) is in compliance with a specified advertisement type, whether targeting criteria are in compliance with specified targeting criteria, etc. In some embodiments where one or more of the asset parameters are not in compliance with the one or more formatting rules, the creative group generation module 230 may, for example, reject the first ad asset, automatically modify the first ad asset such that it is compliance with the one or more formatting rules, prompt the user to make an election that instructs the creative group generation module 230 to modify the first ad asset such that it is compliance with the one or more formatting rules using for example, a notification user interface as described below with reference to FIG. 7, or some combination thereof.

Once the asset parameters comply with the one or more formatting rules, the creative group generation module 230 generates a creative group that is associated with the formatted ad asset and an advertising concept associated with the formatted ad asset. Generating a creative group refers either to creating a new creative group or associating an ad asset with an existing creative group. For example, in embodiments where a creative group already exists that is associated with the same advertising concept as the ad asset—the creative group generation module 230 adds the ad asset to the pre-existing creative group. In contrast, in embodiments where no creative group exists that is associated with the same advertising concept as the ad asset, the creative group generation module 230 creates a new creative group that is associated with the advertising concept and associates the ad asset with the newly created creative group.

The selection module 235 receives requests for advertisements from publishing systems 130. For example, when there is an impression opportunity to display an ad to a viewing user, the publishing system 130 may send a request to the online ad system 140 for an ad to fill an ad placement location on a web page. The requests from the publishing system 130 specify the ad placements to be filled and include ad selection information. Ad selection information is information provided by the publishing system 130 to the online ad system 140 that may be used by the selection module 235 to select an advertisement to fill the ad placement. Ad selection information may include, for example, information identifying a viewing user (e.g., a user to whom an ad will be presented), targeting criteria associated with the viewing user (e.g., age, gender, location, previous visits to advertiser's website, type of client device 110, etc.), supported advertisement types (e.g., animation, video, etc.) for a client device associated with the viewing user, dimensions for an advertisement slot, some other information that may be used by the online advertising system 140 to select an advertisement, or some combination thereof.

The selection module 235 identifies advertising campaigns based in part on the requests for advertisements that specify ad placements. There may be a plurality of different ad campaigns being stored in the content store 210. Each of these ad campaigns is associated with one or more ad placements. A request for an advertisement received from a publishing system 135 includes information that specifies a particular ad placement, the selection module 235 identifies an advertising campaign by identifying the ad campaign that is associated with the specified ad placement.

The selection module 235 selects ad sets that are associated with the identified advertising campaign, the selected ad sets may be used to provide advertisements to fill ad placements. The selecting is based in part on the selection information and a set of selection rules associated with the ad set. As noted above with reference to the content store 210, each of the ad sets is associated with a respective set of selection rules. The selection rules generally control selection of an ad set, and are generally set by the advertiser. The selection rules may include, for example, targeting criteria for the ad set, priority information for the ad set within the ad placement relative to other ad sets, and frequency information that controls how often a particular advertisement may be provided to fill an ad placement. The selection module 235 ranks the ad sets within the identified ad campaigns in accordance with their priority information.

The selection module 235 determines one or more characteristics of the viewing user based in part on the ad selection information. In embodiments, where the ad selection information includes information identifying the viewing user, the online advertising system 140 may identify a user profile that is associated with the viewing user and extract one or more characteristics of the viewing user from the user profile. In embodiments where no user profile exists, the selection module 235 may infer one or more characteristics about the viewing user based in part on the ad placement being filled, history of ad placements for the viewing user, viewing history of the viewing user, some other information about the viewing user in the ad selection information, or some combination thereof. The selection module 235 compares the determined user characteristics to targeting criteria of the ad sets in accordance with their ranking to select an ad set.

The selection module 235 selects a creative group within selected ad sets based in part on the selection rules associated with the selected ad sets. The selection module 235 selects a creative group within a selected ad set by, for example, using the frequency information associated with the ad set. The frequency information indicates how often a particular creative group within the selected ad asset may be used to fill an ad placement. In alternate embodiments, the online advertising system 140 may, for example, randomly select a creative group within the ad set, sequentially select a creative group, etc.

The selection module 235 selects an advertisement within selected creative groups using portions of the ad selection information and one or more asset parameters associated with the advertisements in the selected creative groups. For a given creative group, the selection module 235 checks portions of the ad selection information (e.g., supported advertisement type, ad dimensions) against one or more of the asset parameters associated with ad assets in the creative group to identify a compatible advertisement (i.e., the client device 110 of the user being served the advertisement is capable of presenting the advertisement to a viewing user). The selection module 235 provides the selected advertisement to the web server 245.

The online advertising system 140 provides the selected advertisement to fill the ad placement. In some embodiments, the online advertising system 140 provides the selected advertisement to the publishing system 135 then provides the advertisement to the viewing user. In other embodiments, the online advertising system 140 provides the selected advertisement to the client device 110 associated with the viewing user.

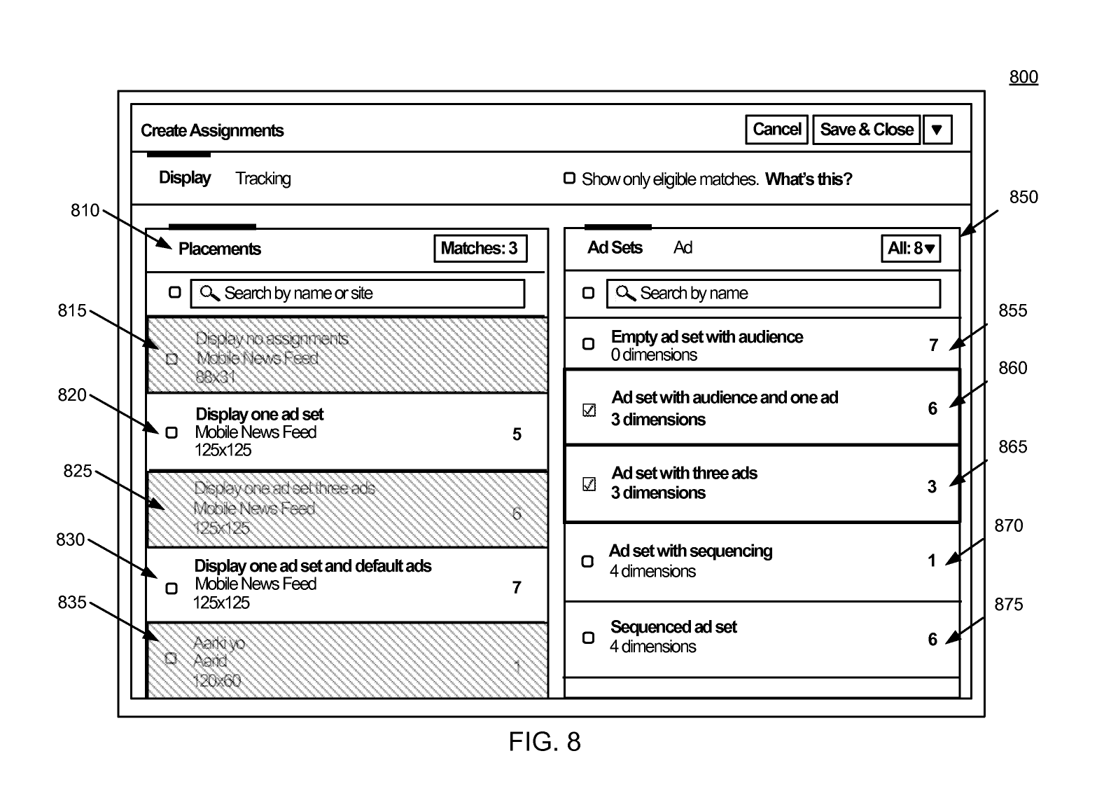

In some embodiments, the management module 240 generates an assignment user interface. The assignment user interface enables the advertiser to match the ad sets for an advertising campaign to a plurality of ad placements that the advertiser has purchased. Accordingly, the assignment user interface facilitates the advertiser receiving confirmation that the campaign has at least some ad coverage for all purchased placements. An example assignment user interface is discussed below with regard to FIG. 8.

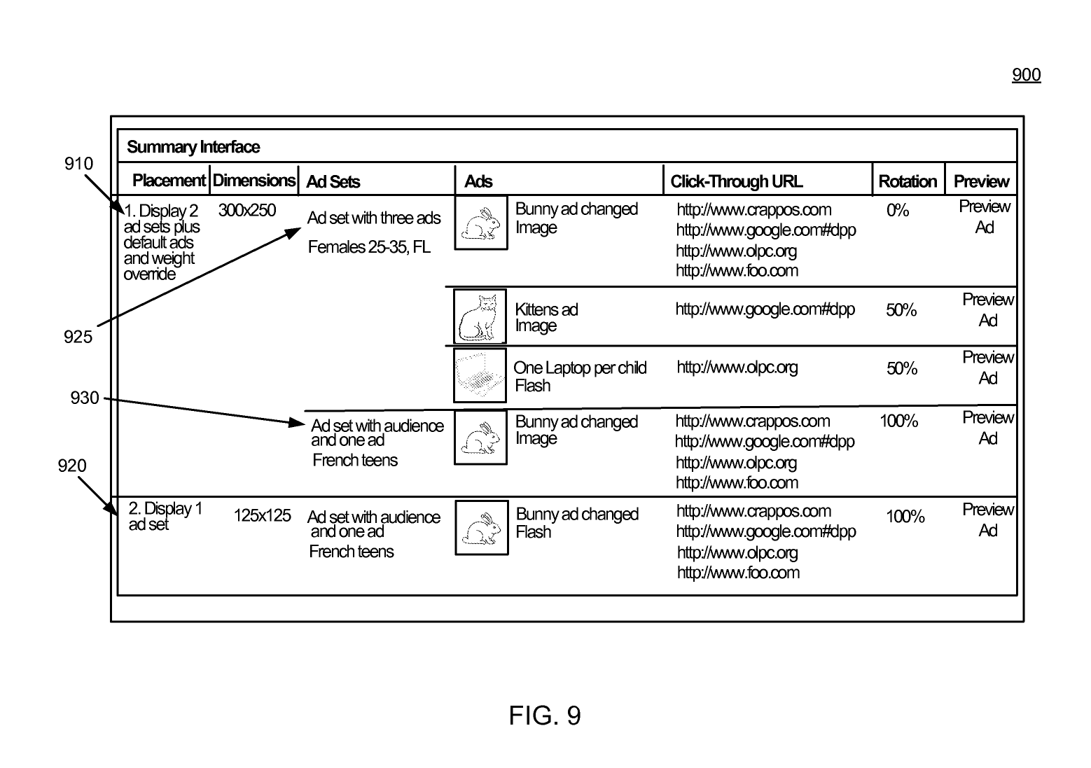

The management module 240 generates a summary user interface based on the one or more ad placements and the one or more ad sets. The summary user interface includes the advertiser's purchased one or more ad placements for the one or more publishing systems. An example summary user interface is discussed below with regard to FIG. 9.

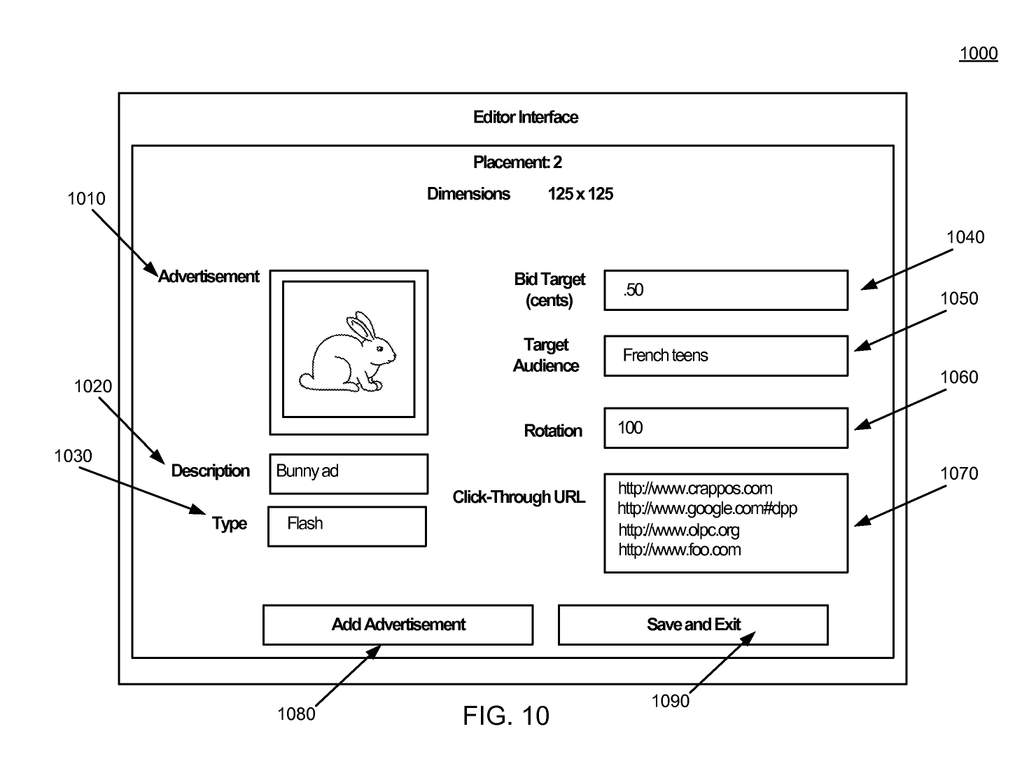

The management module 240 receives, via the summary user interfaces, selections of ad placements by users (e.g., advertisers). Responsive to a given selections, the management module 240 generates an editor user interface, and provides the generated editor user interfaces to the user (e.g., advertiser) who made the selection. The editor user interface includes placement details about the selected ad placement. Placement details provide additional information about the ad sets associated with the selected ad placement. Placement details may include, for example, a description of ad sets and/or advertisements within the ad sets, bid prices of the ad sets and/or advertisements within the ad sets, targeting criteria associated with advertisements within the ad sets, frequency information associated with advertisements within the ad sets, click-thru URLs associated with advertisements within the ad sets, other information associated with the ad sets, or some combination thereof. An example editor user interface is discussed below with regard to FIG. 10. Advertisers are able to modify (e.g., add, edit, or delete) information associated with the placement details for the selected ad placement via the editor user interface. The management module 240 automatically updates the summary user interface based on the editor user interface indicating that one or more of the placement details associated with the selected ad placement have been modified via the editor user interface.

The web server 245 links the online advertising system 140 via the network 120 to the one or more client devices 110, as well as to the one or more advertiser systems 130, and one or more publishing systems 135. The web server 140 serves web pages, as well as other web-related content, such as JAVA®, FLASH®, XML and so forth. The web server 245 may receive and route messages between the online advertising system 140 and the client device 110, for example, instant messages, queued messages (e.g., email), text messages, short message service (SMS) messages, or messages sent using any other suitable messaging technique. The web server 245 may receive and route advertisements (ad assets) and related information (e.g., notification user interfaces, assignment user interfaces, summary user interfaces, and editor user interfaces) between the online advertising system 140 and the client device 110A, the publishing system 135, and the advertising system 130. Additionally, the web server 245 may provide application programming interface (API) functionality to send data directly to native client device operating systems, such as IOS®, ANDROID™, WEBOS® or RIM®.

### Methods for Utilizing Creative Groups in Selecting and Placing Advertisements

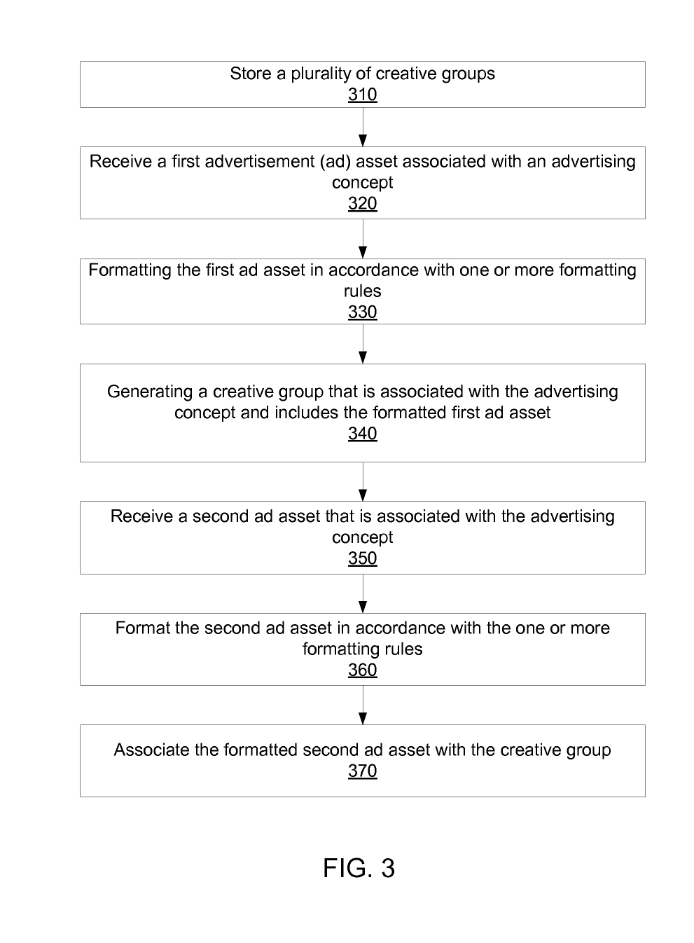

FIG. 3 is a flowchart illustrating a process for generating a creative group, according to an embodiment. In one embodiment, the process of FIG. 3 is performed by the online advertising system 140. Other entities may perform some or all of the steps of the process in other embodiments. Likewise, embodiments may include different and/or additional steps, or perform the steps in different orders.

The online advertising system 140 stores 310 a plurality of creative groups. As noted above, each creative group is associated with its own advertising concept, and includes one or more ad assets that are also associated with the advertising concept. For a particular creative group, each ad asset within that creative group is associated with its own asset parameters. The asset parameters describe specific features of the advertisement. Asset parameters may include, e.g., a size parameter that defines the dimensions of the advertisement, an advertisement type that indicates the type of advertisement (e.g., text, image, audio, animation, video, etc.), targeting criteria, etc. The creative groups and advertisements for the creative groups may be provided by, for example, one or more advertisers.

The online advertising system 140 receives 320 a first ad asset that is associated with an advertising concept. For example, an advertiser may provide the first ad asset to the online advertising system 140 via, e.g., a creative group user interface as described below with reference to FIG. 6. The first ad asset may be provided to the online advertising system 140 to, e.g., set up and/or manage an ad campaign. The online advertising system 140 provides the creative group user interface to a device (e.g., client device 110, a publication system 135, an advertiser system 130, or some other device) for presentation to a user (e.g., advertiser), and receives the first ad asset from the device. The first ad asset is associated with a first set of asset parameters that includes a first size parameter that defines a size of the first ad asset.

The online advertising system 140 formats 330 the first ad asset in accordance with one or more formatting rules. The online advertising system 140 determines whether the first set of asset parameters are in compliance with the one or more formatting rules by checking one or more of the first set of asset parameters against one or more of the formatting rules. For example, the online advertising system 140 may check whether the dimensions of the first ad asset are in compliance with standard advertisement dimensions, whether an advertisement type (e.g., text, image, audio, animation, video, etc.) is in compliance with a specified advertisement type, whether targeting criteria are in compliance with specified targeting criteria, etc. If the first set of asset parameters are in compliance with the one or more formatting rules the process flow moves to step 340. In some embodiments where one or more of the asset parameters are not in compliance with the one or more formatting rules the online advertising system 140 may, for example: reject the first ad asset, automatically modify the first ad asset such that it is compliance with the one or more formatting rules, prompt the user to make an election that instructs the online advertising system 140 to modify the first ad asset such that it is compliance with the one or more formatting rules, or some combination thereof.

For example, the online advertising system 140 retrieves a size parameter that describes the dimensions of the first ad asset from the first set of asset parameters. The online advertising system 140 compares the size parameter to one or more of the one or more formatting rules that describe standard advertisement sizes to determine whether the ad asset is of a standard size. If the size parameter indicates the first set of asset parameters are in compliance with the one or more formatting rules (e.g., first ad asset has standard dimensions) the process flow moves to step 340.

If the ad asset does not have standard dimensions, the online advertising system 140 determines one or more alternate standard dimensions for the first ad asset. For example, assuming that the first ad asset is too large, the online advertising system 140 may determine that the original dimensions of the first ad asset are not standard and that the first ad asset should be formatted (e.g., cropped) to one or more standard dimensions. In embodiments, where the dimensions of the first ad asset are smaller than the smallest standard dimension, the determined alternate dimension is typically the smallest standard dimension, however, in some embodiments it may be a standard dimension larger than the smallest standard dimension.

In some embodiments, the online advertising system 140 generates a notification user interface as described below with reference to FIG. 7 that notifies the user that the dimensions of the first ad asset are not in compliance with the formatting rules and provides the determined one or more alternate dimensions for selection by the user. In alternate embodiments, if the ad asset is not a standard size, the online advertising system 140 automatically determines a standard size closest to the original dimensions of the first ad asset and formats the dimensions of the first ad asset such that it complies with the determined standard size. While the above example is specific to ensuring the dimensions of the ad asset are in compliance with the formatting rules, similar processes may also be used for other asset parameters.

The online advertising system 140 generates 340 a creative group that is associated with the advertising concept and that includes the formatted first ad asset. In some embodiments, the online advertising system 140 prompts the user for additional information to describe the creative group. For example, the online advertising system may prompt (e.g., via a creative group user interface as described below with regard to FIG. 6) the user for a title of the creative group or some other parameters that are associated with the creative group. In other embodiments, the online advertising system 140 determines the additional information that describes the creative group from information received via the creative group interface. In embodiments where a creative group already exists that is associated with the advertising concept instead of generating a new creative group, the online advertising system 140 associates the first ad asset to the pre-existing creative group.

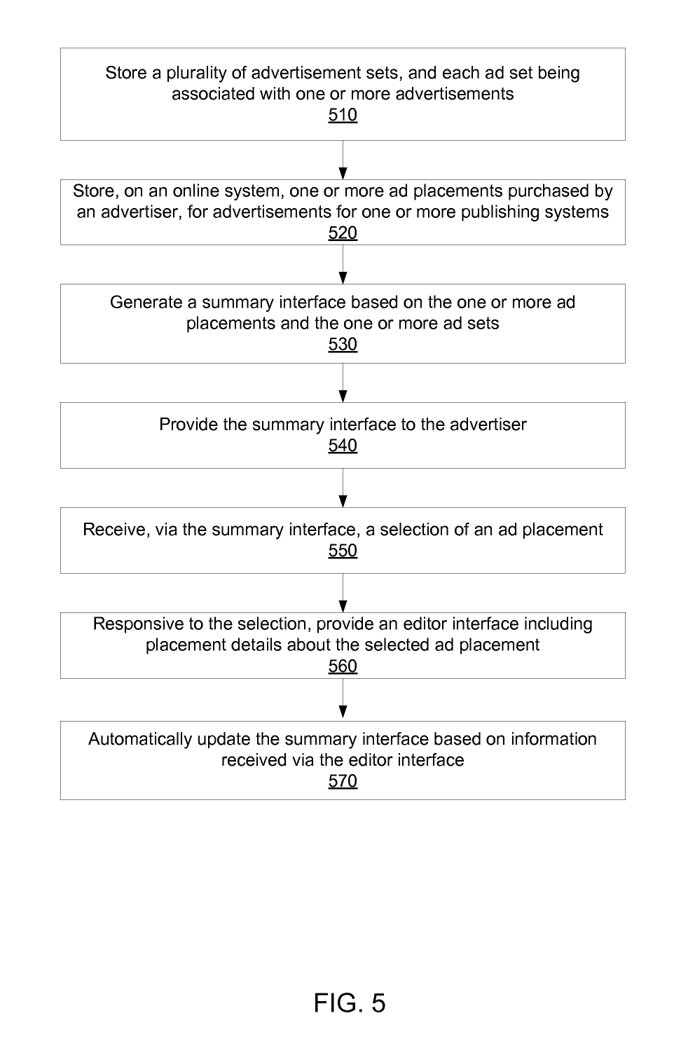

The online advertising system 140 receives 350 a second ad asset that is associated with the advertising concept. The second ad asset is also associated with a second set of asset parameters. The second set of asset parameters includes a second size parameter which in some embodiments is different from the first size parameter. The online advertising system 140 receives the second ad asset via a creative group user interface as described below with reference to FIG. 5. The online advertising system 140 provides the creative group user interface to a device (e.g., client device 110, a publication system 135, an advertiser system 130, or some other device) for presentation to a user, and receives the second ad asset from the device.

The online advertising system 140 formats 360 the second ad asset in accordance with the one or more formatting rules in a substantially similar manner to that described above at step 330. The online advertising system 140 associates 370 the formatted second ad asset with the creative group. Accordingly, the creative group includes the first ad asset and the second ad asset that are both associated with the same advertising concept. As the various asset parameters differ between the first and second ad asset and possibly other ad assets in the creative group, more advertisements are able to be served from the creative group that accommodate various display conditions (e.g., different sized slots for advertisements in content, ability to present animations (FLASH content), etc.).

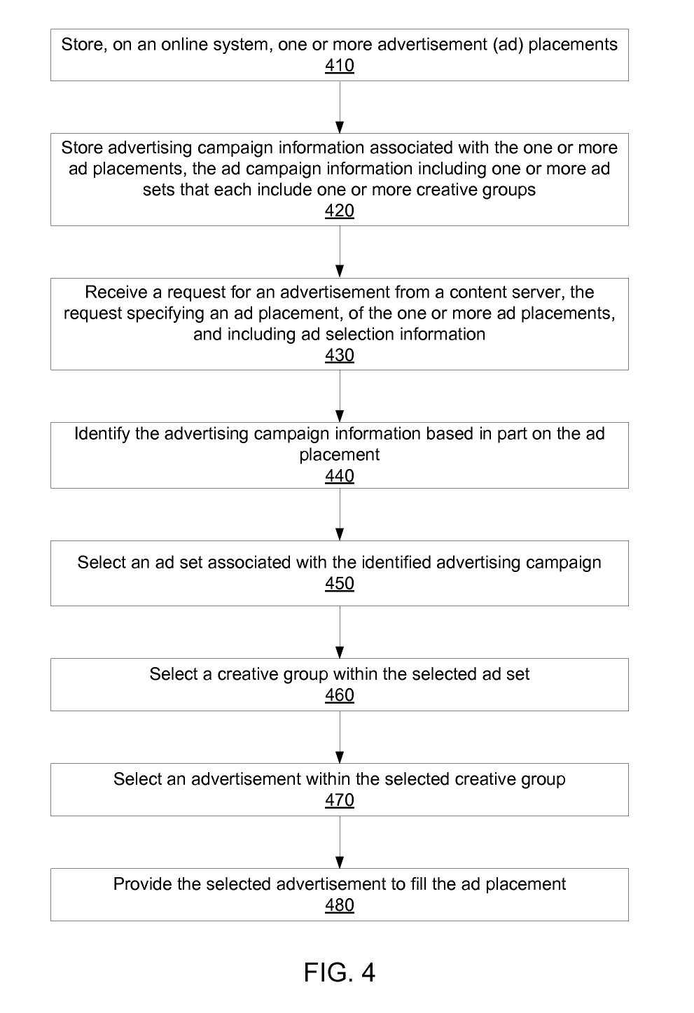

FIG. 4 is a flowchart illustrating a process for serving advertisements using advertisements in creative groups, according to an embodiment. In one embodiment, the process of FIG. 4 is performed by the online advertising system 140. Other entities may perform some or all of the steps of the process in other embodiments. Likewise, embodiments may include different and/or additional steps, or perform the steps in different orders.

The online advertising system 140 stores 410 one or more advertisement placements, purchased by an advertiser, for advertisements for one or more publishing systems 135.

The online advertising system stores 420 an advertising campaign provided by the advertiser. The advertising campaign is associated with the one or more ad placements and includes a plurality of ad sets that are each associated with one or more creative groups.

As noted above, each creative group is associated with its own advertising concept, and includes one or more ad assets (advertisements) that are also associated with the advertising concept. For a particular creative group, each ad asset within that creative group is associated with its own asset parameters (e.g., a size parameter, an advertisement type, etc.). In this embodiment, the plurality of ad sets includes at least one ad set that is associated with a creative group that includes plurality of ad assets (advertisements) that have at least one differing asset parameter (e.g., size parameter, advertisement type, etc.).

Each of the ad sets is associated with a respective set of selection rules. The selection rules generally control selection of an ad set. The selection rules may include, for example, targeting criteria for the ad set, priority information for the ad set within the ad placement relative to other ad sets, and frequency information that controls how often a particular advertisement may be provided to fill an ad placement.

The online advertising system 140 receives 430 a request for an advertisement from a publishing system 130, the request specifying an ad placement, of the one or more ad placements, and including ad selection information. For example, where there is an impression opportunity to display an ad to a viewing user on a web page associated with the publishing system 130, the publishing system 130 can send a request to the online advertising system 140 for an ad to fill that placement. Ad selection information is information that may be provided by the publishing system with the request for an ad and may be used by the online advertising system 140 to select an advertisement to fill the ad placement. Ad selection information may include, for example, information identifying a viewing user, targeting criteria associated with the viewing user, supported advertisement types for a client device associated with the viewing user, dimensions for an advertisement slot, some other information that may be used by the online advertising system 140 to select an advertisement, or some combination thereof.

The online advertising system 140 identifies 440 the advertising campaign based in part on the ad placement. For example, the online advertising system 140 may match the ad placement to an associated ad campaign based on the advertiser associated with the advertising campaign having purchased the ad placement to be filled.

The online advertising system 140 selects 450 at least one ad set included in the identified advertising campaign. The selecting is based in part on the ad selection information and a set of selection rules associated with the ad set. For example, the online advertising system 140 ranks the ad sets within the identified ad campaign in accordance with their priority information (i.e., part of the selection rules). For example, in FIG. 9, for ad placement 1, the ad set with three ads has a higher priority than the ad set with audience and one ad. The online advertising system 140 determines one or more user characteristics, and then compares the determined user characteristics to targeting criteria of the ad sets in accordance with their ranking.

For example, the online advertising system 140 determines one or more characteristics of the viewing user based in part on the ad selection information provided by the publishing system 135. In embodiments, where the selection information includes information identifying the viewing user, the online advertising system 140 determines whether the user has an associated user profile with the online advertising system 140 and/or a user profile on a separate social networking system. If a user profile exists, the online advertising system 140 may then extract one or more characteristics of the user from the user profile. In embodiments where no user profile exists, the online advertising system 140 may infer one or more characteristics about the viewing user based in part on the ad placement being filled, history of ad placements for the viewing user, viewing history of the viewing user, some other information about the viewing user in the ad selection information, or some combination thereof. The online advertising system 140 then compares the determined one or more user characteristics to targeting criteria of the ad sets in accordance with their ranking. Once the targeting criteria of an ad set is met by the one or more user characteristics, the online advertising system 140 selects the ad set to provide an advertisement to fill the ad placement. For example, the one or more user characteristics may indicate that the viewing user is a female and is 30 years old. The highest ranked ad set may have targeting criteria directed to men—accordingly, its targeting criteria is not met, and the online advertising system 140 moves on to the next highest ranking ad set. Assuming the next highest ranking ad set has targeting criteria directed to women, the targeting criteria is met, and the online advertising system 140 selects the ad set provide an advertisement to fill the ad placement.

The online advertising system 140 selects 460 a creative group within the selected ad set based in part on the selection rules associated with the selected ad set. For example, for the ad set for women for which the targeting criteria is met, there might be three different ads or creative groups of ads that can be selected (e.g., bunny ad creative group, kitten ad creative group, etc.) The online advertising system 140 selects a creative group within the selected ad set by, for example, using the frequency information associated with the ad set. The frequency information indicates how often a particular creative group within the selected ad asset may be used to fill an ad placement. For example, the selected ad asset may include creative groups A, B, and C, and the frequency information may indicate that creative group A may be used 50% of the time, creative group B may be used 50% of the time, and creative group C may be used 0% of the time. Accordingly, the online advertising system 140 would select either creative group A or creative group B in accordance with the frequency information (e.g., if creative group A previously provided an advertisement, the online advertising system 140 would select creative group B and vice versa). In alternate embodiments, the online advertising system 140 may, for example, randomly select a creative group within the ad set, sequentially select a creative group, etc.

The online advertising system 170 selects 470 an advertisement within the selected creative group using portions of the ad selection information and one or more asset parameters associated with the advertisements in the selected creative group. The online advertising system 140 checks portions of the ad selection information (e.g., supported advertisement type, ad dimensions) against one or more of the asset parameters to identify a compatible advertisement. For example, the ad selection information may identify that the ad placement supports advertisements that have dimensions of 300×600 IAB standard size, the online advertising system 140 then identifies an advertisement in the creative group having the same dimensions (e.g., within the bunny ad creative group, it selects the 300×600 IAB version of the bunny ad rather than the 300×250 IAB version of the bunny ad). In embodiments, where the creative group does not contain an advertisement of the same dimensions, the online advertising system 140 may format one of the advertisements in the creative group to the supported dimension.

The online advertising system 140 provides 480 the selected advertisement to fill the ad placement. In some embodiments, the online advertising system 140 provides the selected advertisement to the publishing system 135, which then provides the advertisement to the viewing user. In other embodiments, the online advertising system 140 provides the selected advertisement to the client device 110 associated with the viewing user.

FIG. 5 is a flowchart illustrating a process for updating a summary user interface, according to an embodiment. In one embodiment, the process of FIG. 5 is performed by the online advertising system 140. Other entities may perform some or all of the steps of the process in other embodiments. Likewise, embodiments may include different and/or additional steps, or perform the steps in different orders.

The online advertising system 140 stores 510 a plurality of ad sets, and each ad set is associated with one or more advertisements and/or creative groups. The online advertising system 140 also stores 520 one or more ad placements, purchased by an advertiser, for advertisements for one or more publishing systems.

The online advertising system 140 generates 530 a summary user interface based on the one or more ad placements and the one or more ad sets. The summary user interface including the advertiser's purchased one or more ad placements for the one or more publishing systems. An example, summary user interface is discussed below with regard to FIG. 9. The online advertising system 140 provides 540 the summary user interface to the advertiser. For example, the online advertising system 140 may provide the summary user interface to a client device 110 associate with the advertiser and/or the advertising system 130.

The online advertising system 140 receives 550, via the summary user interface, a selection of an ad placement, of the one or more ad placements. Responsive to the selection, the online advertising system 140 provides 560 an editor user interface to the advertiser. The editor user interface includes placement details about the selected ad placement. Placement details provide additional information about the ad sets associated with the selected ad placement. Placement details may include, for example, a description of ad sets within the ad placement, a description of advertisements within the ad sets, bid prices of the ad sets within the ad placement, bid prices for advertisements within the ad sets, targeting criteria associated with advertisements within the ad sets, frequency information associated with advertisements within the ad sets, click-thru URLs associated with advertisements within the ad sets, other information associated with the ad sets, or some combination thereof. An example editor user interface is discussed below with regard to FIG. 10. The advertiser is able to modify (e.g., add, edit, or delete) information associated with the placement details for the selected ad placement via the editor user interface. For example, the advertiser may add an additional ad set to the existing ad sets associated with the ad placement.

The online advertising system 140 automatically updates 570 the summary user interface based on the editor user interface indicating that one or more of the placement details associated with the selected ad placement have been modified via the editor user interface. Accordingly, the online advertising system 140 facilitates the advertiser being able to easily view what ad sets are associated with what ad placements via the summary user interface—and facilitates modification of the placement details about the ad sets associated with a selected ad placement via the editor user interface.

User Interfaces for Utilizing Creative Groups in Selecting and Placing Advertisements

FIG. 6 illustrates a creative group user interface 600 that allows a user to edit a creative group, according to an embodiment. The creative group user interface 600 includes a group information section 610 and an asset information section 620. The group information section 610 includes information describing the creative group. The group information section 610 includes, for example, a name interface 612, a frequency cap interface 614, a custom parameter interface 616, ad additional code interface 618, an icon 619 associated with the advertising concept of the creative group, some other information describing the creative group, or some combination thereof. The name interface 612 allows a user to enter and/or edit a name (e.g., “Finish Line”) of the creative group. The frequency cap interface 614 allows the user to enable/disable a frequency cap for the creative group. A frequency cap controls the frequency with which the online server 140 selects and serves advertisements from the creative group. The custom parameter interface 616 enables a user to add parameters specific to the creative group. For example, a user may provide the ability to customize an ad's click-thru URL by dynamically substituting macros on the URL (e.g. campaign ID/name, advertiser ID/name, creative group ID/name). Thus the user/ad viewer is directed to a different landing page (i.e., a web page, application, web site, or other network destination to which a user is directed when accessing an advertisement) based on the value of the parameter when the ad is delivered. More generally, custom parameters provide the ability to run custom code with an ad e.g. display an AdChoices icon. The additional code interface 618 enables a user to enable/disable one or more additional features (e.g., extra tracking, reporting, vendor code, etc.). The icon 619 is a graphic image which represents the advertising concept (e.g., a bicycle) associated with the creative group.

The asset information section 620 includes ad assets associated with the creative group. In this example, the asset information section 620 includes ad assets 625, 630, 635, and 640. Each ad asset 625, 630, 635, 640 is associated with the advertising concept. In this example, the ad assets 625, 630, 635, 640 are each images files associated with the same advertising concept. In this embodiment the ad assets 625, 630, 635, and 640 have different dimensions (e.g., ad asset 625 is 300×250 and ad asset 630 is 300×600). In other embodiments, one or more ad assets may have the same dimensions. Additionally, while each of the ad assets have a type “image,” in some embodiments, one or more of the ad assets may have a type other than image (e.g., animation, audio, etc.). The asset information section 620 also includes an add button 645, which enables a user to add an additional ad asset to the creative group.

FIG. 7 illustrates a notification user interface 700 that notifies a user that the dimensions of an advertisement are out of compliance with standard dimensions, according to an embodiment. The notification user interface 700 includes a notice section 710 and an election section 720. The notice section 710 includes information indicating that the dimensions of the advertisement do not match standard dimensions. In some embodiments, the standard dimensions are determined by the Interactive Add Bureau (IAB), and specify one or more standard dimensions for advertisements. The election section 720 provides one or more options that the user may choose from to address the advertisement having non-standard dimensions. For example, a user may elect: a recommended standard dimension for the advertisement, an option causing the online advertising system 140 to accept the dimensions of the advertisement, to not associate the advertisement with the creative group, etc. In alternate embodiments, the notification user interface 700 may notify the user that other aspects of the advertisement are out of compliance with one or more formatting rules. For example, the advertisement may be of the wrong advertisement type, wrong targeting criteria, etc.

FIG. 8 illustrates an assignment user interface 800 that enables a user to assign advertisements to ad placements, according to an embodiment. The assignment user interface 800 includes an ad placement interface 810 and an ad interface 820. The ad placement interface 810 lists ad placements which have been purchased by an advertiser. In this example, the ad placement interface 810 lists ad placements 815, 820, 825, 830, and 835. The listed ad placements may include a number indicating the number of ad sets or advertisements that are currently assigned to the ad placement. For example, 5 ad sets are assigned to the ad placement 820.

The ad interface 820 lists advertisements or ad sets that are available for ad placement. In this example, the ad interface 820 lists ad sets 855, 860, 865, 870, and 875. The listed ad sets may include a number indicating the number of ad placements of the ad set across one or more publishers. For example, the ad set 860 has been placed 6 times across one or more publishers.

A user may select an ad set, and the assignment user interface 800 automatically emphasizes what ad placements are compatible (e.g., compatible dimensions, advertisement type, etc.) with the selected ad sets. In FIG. 8, the ad sets 860 and 865 are selected and the assignment user interface 800 has emphasized compatible ad placements 820 and 830 by graying out the ad placements 815, 825, and 835. Similarly, a user may select an ad placement and the assignment user interface 800 automatically emphasizes what ad sets or advertisements are compatible with the selected ad placements.

FIG. 9 illustrates a summary user interface 900 that allows a user to review advertisement placements, according to an embodiment. The summary user interface 900 presents a portion of the advertiser's purchased ad placements across all publishing systems 135. In some embodiments the portion of the advertiser's purchased ad placements is all of the purchased ad placements across all publishing systems 135. The summary user interface 900 summarizes information associated with the ad placement. For example, the user interface 900 may display, for example, information describing the ad placement, dimensions for advertisements associated with the ad placement, ad sets associated with the ad placement, advertisements associated with the ad placement, click-thru URLs associated with the advertisements, rotation percentage (frequency information that describes what percentage of time an advertisement within ad set is served compared to other ads in the ad set), a preview option, some other information associated with the ad placement, or some combination thereof.

In this example, the summary user interface 900 lists ad placement 910 and ad placement 920. The ad placement 910 includes ad set 925 and ad set 930. The ad set 925 includes three different ads that are targeted toward females who are 25 to 35 years old and are associated with Florida. In some embodiments the ads presented are associated with creative groups. The ad set 925 includes a bunny ad and a kitten ad which are images, and a computer ad which is FLASH file. In contrast, the ad set 930 includes only an ad for a bunny. The computer ad and the kitten ad are each set at 50% rotation for the ad set 925, accordingly, the online advertising system 140 would rotate between the computer ad and the kitten ad when serving advertisements from the ad set 925. The placement 920 includes only a single ad set that include only one advertisement for a bunny. An advertiser can select a placement (e.g., the placement 920), which causes the online advertising system 140 to generate an editor user interface providing additional detail about the placement as discussed below with regard to FIG. 10.

FIG. 10 illustrates an editor user interface 1000 that allows a user (e.g., an advertiser) to edit individual ad placements, according to an embodiment. The editor user interface 1000 presents additional details about an ad placement selected from the summary user interface 900. For example, the editor user interface 1000 is presenting placement details about the ad placement 920. Placement details provide additional information about the ad sets associated with the selected ad placement. In FIG. 10, the placement details are presented to the user via a plurality of interfaces, specifically, an advertisement interface 1010, a description interface 1020, an advertisement type interface 1030, a bid target interface 1040, a target audience interface 1050, a rotation interface 1060, a click-thru URL interface 1070, an add advertisement button 1080, an exit button 1090, some other information about the placement, or some combination thereof.

The user is able to review and/or edit some of the placement details using the plurality of interfaces. The advertiser interface 1010 displays the advertisement to the advertiser. The description interface 1020 enables the advertiser to edit a description of the advertisement. The bid target interface 1040 allows the advertiser to edit a bid price. The target audience interface 1050 allows the advertiser to edit the targeting criteria. The rotation interface 1060 allows the advertiser to edit the rotation for the advertisement. The click-thru URL interface 1070 allows the advertiser to edit one or more URLs to be associated with the advertisement. The add button 1080 allows a user to add an additional advertisement to the selected placement. Once the advertiser is done with the selected placement, the advertiser may select the exit button 1090. Responsive to edits made to an ad placement in the editor user interface 1000, the online advertising system 140 automatically updates the information associated with the edited ad placement in the summary user interface 900.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
storing a plurality of advertisement (ad) sets, wherein each ad set is associated with one or more advertisements;
storing, on an online advertising system, one or more ad placements, purchased by an advertiser, for advertisements for one or more publishing systems;
generating a summary user interface based on the one or more ad placements and the one or more ad sets, the summary user interface including the advertiser's purchased one or more ad placements for the one or more publishing systems;
providing the summary user interface to the advertiser;
receiving, via the summary user interface, a selection of an ad placement, of the one or more ad placements;
responsive to the selection, providing an editor user interface to the advertiser, the editor interface including placement details about the selected ad placement, the placement details providing information about the ad sets associated with the ad placement; and
automatically updating the summary user interface based on information received via the editor user interface that modifies one or more of the placement details associated with the selected ad placement.

2. The method of claim 1, wherein placement details comprise: a description of advertisements within the ad sets, a description of ad sets within the ad placement, bid prices of the ad sets within the ad set, bid prices of advertisements within the ad sets, targeting criteria associated with advertisements within the ad sets, frequency information associated with advertisements within the ad sets, and click-thru URLs associated with advertisements within the ad sets.

3. The method of claim 1, wherein the summary user interface presents, for each ad placement, portions of the placement details information for ad sets associated with the displayed ad placements.

4. The method of claim 1, wherein automatically updating the summary user interface based on information received via the editor user interface that modifies one or more of the placement details associated with the selected ad placement, comprises:
receiving an advertisement via the editor user interface, wherein the advertisement is compliant with a size of the ad placement;
adding the advertisement to the ad placement; and
updating the summary user interface to show the added advertisement as part of the ad placement.

5. The method of claim 4, wherein the advertisement complies with a supported type of advertisement for the ad placement.

6. A method comprising:
generating a summary user interface that includes one or more ad placements and one or more ad sets, wherein the one or more ad placements for one or more publishing systems;
providing the summary user interface to an advertiser;
receiving, via the summary user interface, a selection of an ad placement, of the one or more ad placements;
responsive to the selection, providing an editor user interface to the advertiser, the editor interface including placement details about the selected ad placement, the placement details providing information about the ad sets associated with the ad placement; and
automatically updating the summary user interface based on information received via the editor user interface that modifies one or more of the placement details associated with the selected ad placement.

7. The method of claim 6, wherein placement details comprise: a description of advertisements within the ad sets, a description of ad sets within the ad placement, bid prices of the ad sets within the ad set, bid prices of advertisements within the ad sets, targeting criteria associated with advertisements within the ad sets, frequency information associated with advertisements within the ad sets, and click-thru URLs associated with advertisements within the ad sets, other information associated with the ad sets.

8. The method of claim 6, wherein the summary user interface presents, for each ad placement, portions of the placement details for ad sets associated with the displayed ad placements.

9. The method of claim 6, wherein automatically updating the summary user interface based on information received via the editor user interface that modifies one or more of the placement details associated with the selected ad placement, comprises:
receiving an advertisement via the editor user interface, wherein the advertisement is compliant with a size of the ad placement;
adding the advertisement to the ad placement; and
updating the summary user interface to show the added advertisement as part of the ad placement.

10. The method of claim 9, wherein the advertisement complies with a supported type of advertisement for the ad placement.

11. A system comprising:
a processor; and
a computer-readable storage medium coupled to the processor, the computer-readable storage medium having instructions encoded thereon that, when executed by the processor, cause the processor to:
store a plurality of advertisement (ad) sets, wherein each ad set is associated with one or more advertisements;
store, on an online advertising system, one or more advertisement (ad) placements, purchased by an advertiser, for advertisements for one or more publishing systems;
generate a summary user interface based on the one or more ad placements and the one or more ad sets, the summary user interface including the advertiser's purchased one or more ad placements for the one or more publishing systems;
provide the summary user interface to the advertiser;
receive, via the summary user interface, a selection of an ad placement, of the one or more ad placements;
responsive to the selection, provide an editor user interface to the advertiser, the editor interface including placement details about the selected ad placement, the placement details providing information about the ad sets associated with the ad placement; and
automatically update the summary user interface based on information received via the editor user interface that modifies one or more of the placement details associated with the selected ad placement.

12. The system of claim 11, wherein placement details comprise: a description of advertisements within the ad sets, a description of ad sets within the ad placement, bid prices of the ad sets within the ad set, bid prices of advertisements within the ad sets, targeting criteria associated with advertisements within the ad sets, frequency information associated with advertisements within the ad sets, and click-thru URLs associated with advertisements within the ad sets, other information associated with the ad sets.

13. The system of claim 11, wherein the summary user interface presents, for each ad placement, portions of the placement details for ad sets associated with the displayed ad placements.

14. The system of claim 1, wherein automatically update the summary user interface based on information received via the editor user interface that modifies one or more of the placement details associated with the selected ad placement, comprises:
receiving an advertisement via the editor user interface, wherein the advertisement is compliant with a size of the ad placement;
adding the advertisement to the ad placement; and
updating the summary user interface to show the added advertisement as part of the ad placement.

15. The system of claim 14, wherein the advertisement complies with a supported type of advertisement for the ad placement.
